(19) United States
(12) Patent Application Publication
(10) Pub. No.: US 2004/0123438 A1
(43) Pub. Date: Jul. 1, 2004

(54) Tool for replacing brake pads of disc braking systems of automobiles

(76) Inventor: Hsin Fa Kang, Tainan City (TW)

Correspondence Address: Kang Hsin Fa, P.O. Box 90, Tainan City, 704, TW

(21) Appl. No.: 10/330,065

(22) Filed: Dec. 30, 2002

(51) Int. Cl. B23P 19/04

(52) U.S. Cl. 29/239

(57) ABSTRACT

A tool for replacing brake pads of disc braking systems of automobiles includes a screw rod combined with a sliding handle and having a ring groove; a first plate body combined with the screw rod and having two through holes; a second plate body screwed with the screw rod and having a screw hole and a through hole respectively aligned with the through holes of the first plate body; a guide rod extending through the through holes of the second plate body and the first plate body and having two ring grooves at both ends. The ring grooves can be engaged with retainer rings. Only to place the first plate body and the second plate body against front ends of more than one piston and to rotate the screw rod forward, a user can press the pistons to their initial positions simultaneously at a time for replacing new brake pads.

### BACKGROUND OF THE INVENTION

1. Field of the Invention

This invention relates to a tool for replacing brake pads of disc braking systems of automobiles, particularly to one provided with a screw rod, a first plate body, a second plate body and a guide rod, by which the tool is capable of easily and quickly pressing more than one piston to their initial positions simultaneously at a time.

2. Description of the Prior Art

Generally speaking, referring to FIGS. 1 and 2, a conventional known tool 1 for replacing brake pads of disc brakes of automobiles includes a screw rod 10, a sleeve 11, a plate body 12 and at least one connector 13 with various sizes as main components. When a piston 15 disposed in a caliper 14 is gradually traveled toward old brake pads with a continuous wearing in linings of the old brake pads, a selective combination of the components is capable of pressing the piston 15 to its initial position for replacing new brake pads. However, such conventional known tool 1 can only press a single piston 15 to its initial position at a time. In case of having more than one piston 15 disposed in the caliper 14, the conventional known tool 1 is unable to press the pistons 15 to their initial positions simultaneously at a time for saving time and labor.

### SUMMARY OF THE INVENTION

The main purpose of the invention is to offer a tool for replacing brake pads of disc braking systems of automobiles that is capable of pressing more than one piston to their initial positions simultaneously at a time.

The main feature of the invention is to provide a tool for replacing brake pads of disc braking systems of automobiles including:

a screw rod having one end provided with an operating rod extended through by and combined with a sliding handle, and the other end provided with a ring groove;

a first plate body capable of being extended through by and combined with the screw rod, and having two through holes respectively disposed at appropriate places thereof;

a second plate body capable of being extended through by and screwed with the screw rod, and having a screw hole and a through hole disposed at appropriate places thereof and respectively aligned with the two through holes of the first plate body; and,

a guide rod capable of extending through the through hole of the second plate body as well as the through hole of the first plate body that is in alignment with the through hole of the second plate body, and having two ring grooves respectively disposed at both ends thereof.

### BRIEF DESCRIPTION OF DRAWINGS

This invention will be better understood by referring to the accompanying drawings, wherein:

FIG. 1 is a perspective view showing the construction of a conventional known tool for replacing brake pads of disc brakes of automobiles;

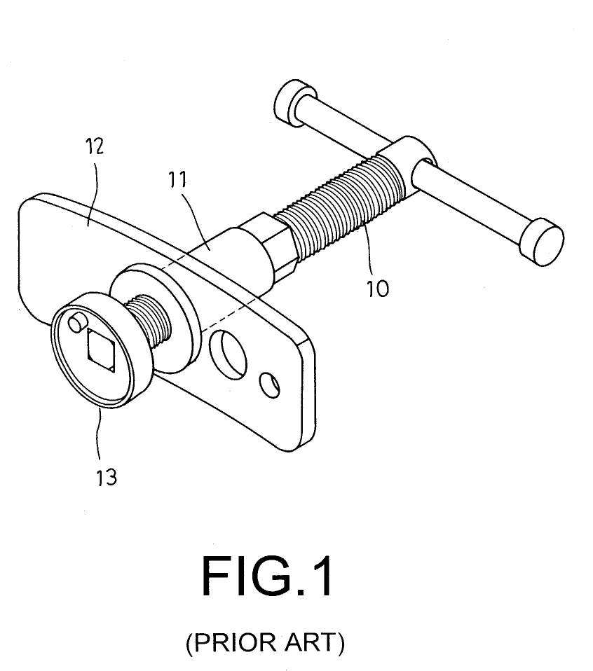

FIG. 2 is a schematic view showing an operational status of the conventional known tool shown in FIG. 1;

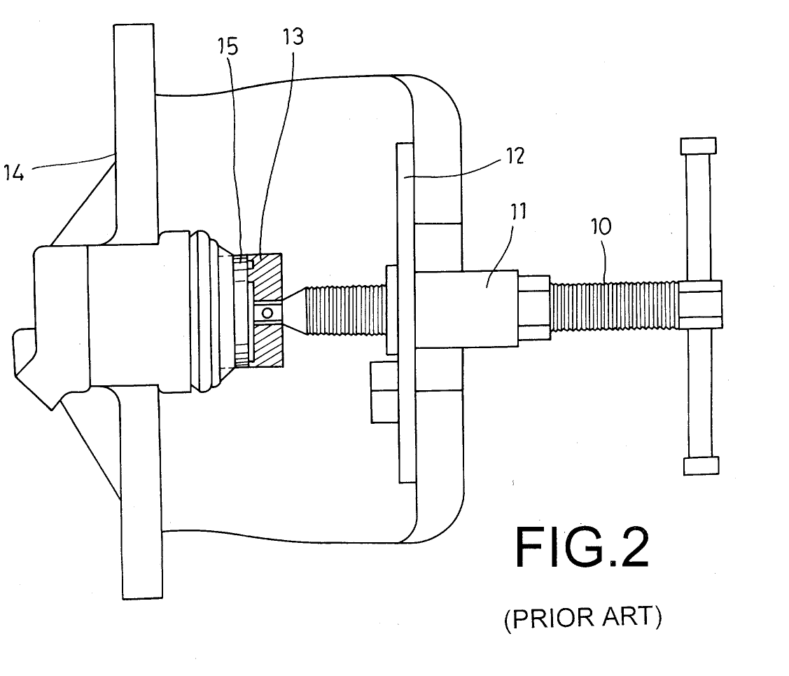

FIG. 3 is an exploded perspective view of a tool for replacing brake pads of disc braking systems of automobiles in the present invention;

FIG. 4 is a perspective view of the tool for replacing brake pads of disc braking systems of automobiles in the present invention; and,

FIG. 5 is a schematic view showing an operational status of the tool for replacing brake pads of disc braking systems of automobiles in the present invention.

### DETAILED DESCRIPTION OF THE PREFERRED EMBODIMENT

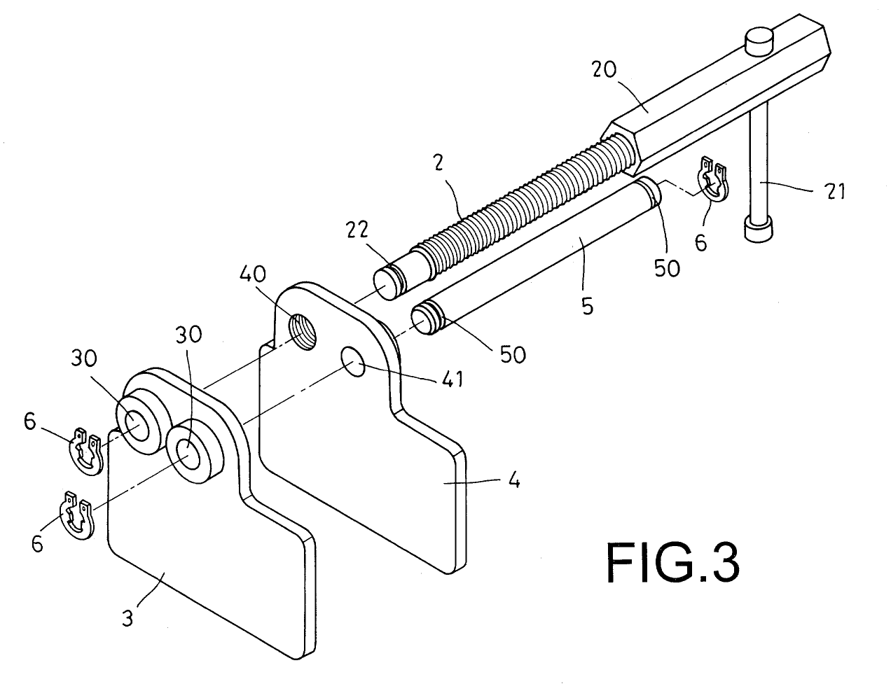

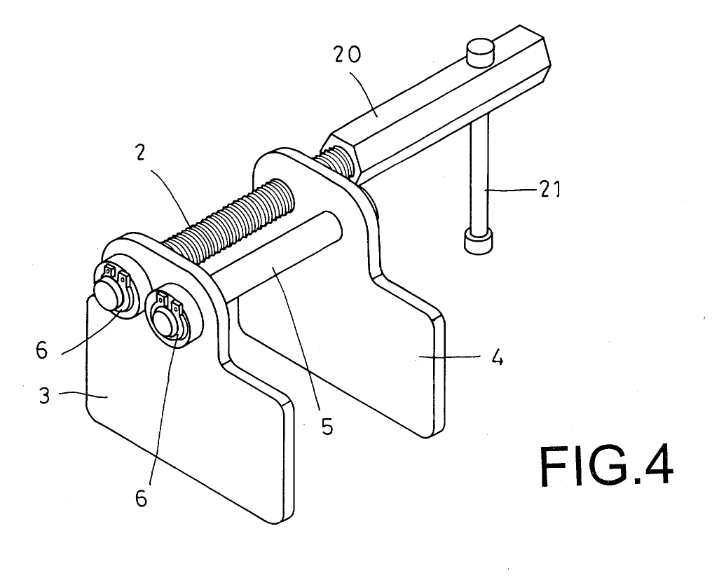

A preferred embodiment of a tool for replacing brake pads of disc braking systems of automobiles in the present invention, as shown in FIGS. 3 and 4, includes a screw rod 2, a first plate body 3, a second plate body 4, a guide rod 5 and a plurality of retainer rings 6.

The screw rod 2 has one end provided with an operating rod 20 capable of being combined with a sliding handle 21 at a proximate end portion thereof, and the other end provided with a ring groove 22. The operating rod 20 in a polygonal shape is convenient to be selectively assembled with other tools, e.g. a wrench, a socket tool, etc. for facilitating the operation of the operating rod 20.

The first plate body 3 capable of being extended through by and combined with the screw rod 2 has two through holes 30, 30 respectively disposed at appropriate places thereof.

The second plate body 4 capable of being extended through by and screwed with the screw rod 2 has a screw hole 40 and a through hole 41 disposed at appropriate places thereof and respectively aligned with the two through holes 30, 30 of the first plate body 3.

The guide rod 5 capable of extending through the through hole 41 of the second plate body 4 as well as one of the two through holes 30, 30 of the first plate body 3 that is in alignment with the through hole 41 of the second plate body 4 has two ring grooves 50 respectively disposed at both ends thereof.

The plurality of retainer rings 6 are capable of being engaged in the ring groove 22 of the screw rod 2 and the two ring grooves 50 of the guide rod 5.

In assembling, referring to FIGS. 3 to 5, firstly extend the screw rod 2 through the screw hole 40 of the second plate body 4, further move the screw rod 2 forward to make the end of the screw rod 2 provided with the ring groove 22 extended through one of the two through holes 30, 30 of the first plate body 3 that is in alignment with the screw hole 40 of the second plate body 4, and then engage one retainer ring 6 in the ring groove 22 of the screw rod 2 so as to make the screw rod 2 firmly combined with the first plate body 3 and the second plate body 4. Secondly, extend the guide rod 5 through the through hole 41 of the second plate body 4 as well as another one of the two through holes 30, 30 of the first plate body 3 that is in alignment with the through hole 41 of the second plate body 4, and then engage two retainer rings 6 respectively in the ring grooves 50 of the guide rod 5 so as to make the guide rod 5 firmly combined with the first plate body 3 and the second plate body 4, by which a whole assemblage of the tool for replacing brake pads of disc braking systems of automobiles of the present invention is completed with convenience and quickness.

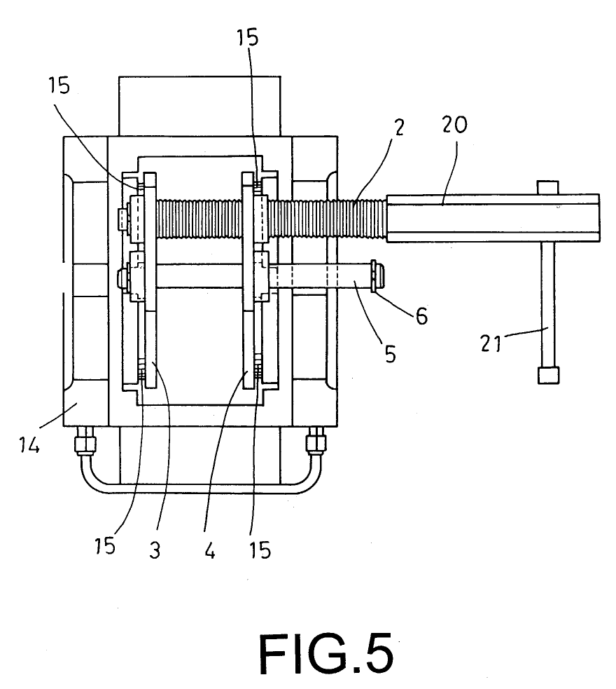

In using, referring to FIG. 5, firstly place the first plate body 3 and the second plate body 4 into a caliper 14 and respectively against front ends of more than one piston 15, and then rotate the screw rod 2 forward to make the first plate body 3 and the second plate body 4 press the pistons 15 to their initial positions simultaneously at a time for the convenience of replacing new brake pads.

The invention has the following advantages and effects, as can be understood from the aforesaid description.

1. In using, the tool of the present invention is capable of pressing more than one piston to their initial positions simultaneously at a time.

2. The tool of the present invention can be operated quickly and steadily without damaging an interior of a caliper of an automobile.

3. The operating rod of the screw rod in a polygonal shape is convenient to be selectively assembled with other tools, e.g. a wrench, a socket tool, etc. for facilitating the operation of the tool to be more easy and laborsaving.

While the preferred embodiment of the invention has been described above, it will be recognized and understood that various modifications may be made therein and the appended claims are intended to cover all such modifications that may fall within the spirit and scope of the invention.

What is claimed is:

1. A tool for replacing brake pads of disc braking systems of automobiles comprising:
a screw rod having one end provided with an operating rod extended through by and combined with a sliding handle, and the other end provided with a ring groove;
a first plate body capable of being extended through by and combined with said screw rod, and having two through holes respectively disposed at appropriate places thereof;
a second plate body capable of being extended through by and screwed with said screw rod, and having a screw hole and a through hole disposed at appropriate places thereof and respectively aligned with said two through holes of said first plate body;
a guide rod capable of extending through said through hole of said second plate body as well as said through hole of said first plate body that is in alignment with said through hole of said second plate body, and having two ring grooves respectively disposed at both ends thereof; and,
whereby only to engage retainer rings in said ring grooves of said screw rod and said guide rod, a user can assemble said screw rod and said guide rod respectively with said first plate body and said second plate body easily; in using, only to place said first plate body and said second plate body respectively against front ends of more than one piston and to rotate said screw rod forward, said user can press said more than one piston to their initial positions simultaneously at a time for the convenience of replacing new brake pads.

2. The tool for replacing brake pads of disc braking systems of automobiles as claimed in claim 1, wherein said operating rod of said screw rod is provided in a polygonal shape convenient for selectively assembled with a wrench capable of clamping at an appropriate place of said operating rod for facilitating the operation of said operating rod.

3. The tool for replacing brake pads of disc braking systems of automobiles as claimed in claim 1, wherein said operating rod of said screw rod is provided in a polygonal shape convenient for selectively assembled with a socket tool capable of being connected with an end of said operating rod for facilitating the operation of said operating rod.
